(19) United States
(12) Patent Application Publication
(10) Pub. No.: US 2009/0258219 A1
(43) Pub. Date: Oct. 15, 2009

(54) Aqueous silicon dioxide dispersions for adhesive formulations

(76) Inventors: Dietrich Pantke, Ratingen (DE); Rüdiger Musch, Bergisch Gladbach (DE)

Correspondence Address: AKZO NOBEL INC., LEGAL & IP, 120 WHITE PLAINS ROAD, SUITE 300, TARRYTOWN, NY, 10591, US

(21) Appl. No.: 12/442,770

(22) PCT Filed: Sep. 25, 2007
(86) PCT No.: PCT/EP07/60149

§ 371 Date: Apr. 30, 2009

(30) Foreign Application Priority Data
Sep. 26, 2006 (DE) 10-2006-045-384.0

(51) Int. Cl. B32B 5/16; C08K 3/36; C08L 5/16

(52) U.S. Cl. 428/327; 524/493; 524/27; 977/773

(57) ABSTRACT

The invention relates to aqueous compositions, particularly aqueous dispersions based on silicon dioxide, and to a method for the production and usage thereof as a component in the production of adhesive layers and for the bonding of the substrates coated on one side or both sides by spray application using the compositions.

The invention pertains to water-containing compositions, in particular aqueous dispersions based on silica, a process for the preparation thereof, as well as the use thereof as components in the preparation of adhesive coatings and for bonding substrates coated on one or both sides by means of spray application using the compositions.

The use of silica products is known from the prior art for various applications, e.g. as binder, in the field of high-quality moulds, as additive for the modification of surfaces, or in the construction sector as additive for shotcrete (cf. e.g. the Levasil® brochure of H. C. Starck GmbH, Goslar, Germany, www.hcstarck.com). Furthermore, mixtures of silica dispersions and polychloroprene dispersions are known. Thus EP-A 0 332 928 discloses the use of polychloroprene lattices in the presence of silica sols as impregnating layer in the preparation of fire protection elements. FR-A 2341537 and FR-A 2 210 699 describe pyrogenic silicas in combination with polychloroprene lattices for the preparation of flame-resistant foam finishes or for the heat treatment of bitumen and in JP-A 06 256 738 they are described in combination with chloroprene-acrylic acid copolymers. Furthermore, the use of silica dispersions in aqueous adhesive systems is known (Ganster et al., “Neue Rohstoffe für lösemittelfreie Kleb- und Dichtstoffen” in the journal Kleben und Dichten, March 2003).

The preparation of adhesive formulations based on polychloroprene dispersions using silica sols is described in WO-A 03/102066. While it is true that these formulations have a long “open time” and a high “thermal stability” of the resulting dry adhesive films, because of their high viscosity they are not suitable to be processed in spray coating processes.

In the case of adhesives, by “open time” is meant according to DIN 16920 the timespan after application of the adhesive within which wet bonding is possible.

This is the time from the application of the adhesive until the employment of applied pressure.

By “thermal stability” is meant the temperature at which an adhesive layer under stress still holds the glued adherends together.

Sprayable contact adhesives based on polychloroprene dispersions are used in various fields, in particular for foam bonding in the mattresses and furniture sector. Here essentially two processes have established themselves:

### 1. The 2C(omponent) Process

In this process adhesive formulation and aqueous coagulation agent are simultaneously atomised by a spray gun which has two nozzles. The two mixtures meet in the spray stream and coagulate there and/or on the substrate surface. This is described e.g. in: Katsuyuki Hara, Institute of Technology, Osaka Japan, “Two part spray mixing water borne adhesive” (World adhesive congress, Munich 8-10 Jun. 1988), or in Technical Information of Bayer Material Science AG, Leverkusen, Germany (KA-KR-0001e/01/05.96.) However, this process is interference-prone and hard to operate, since the two components have to be atomised constantly in a particular ratio of mixture, and is only accepted by the market with some reservations.

### 2. The 1C(omponent) Process

In this process an adhesive formulation with a limited shear stability is atomised through a spray gun with one nozzle. Appropriate aqueous formulations contain organic solvents to destabilise the adhesive dispersion, such as is described e.g. in EP 814 139 A1 or DE 30 28 693 A1. Because of strict environmental regulations the use of solvent-containing 1C formulations is only allowed under tight restrictions. Hence there is a need for solvent-free adhesive formulations.

In EP-A 624 634 A1 and EP-A 470 928 such solvent-free aqueous 1C-formulations are described for the elastic bonding of substrate surfaces. They contain mixtures of acrylate copolymers and polychloroprene. Through the addition of weak acids such as boric acid and other adjuvants the pH value is set to about 8.5. These pressure-sensitive dispersions coagulate on exiting the nozzle of the spray gun. Disadvantageous in this case is the low thermal stability of the formulations, so that they are only useful in “foam-foam bonds”.

Coatings or bonds with high thermal stability are obtained with the aid of the so-called “EPI System” (Emulsion-Polymer-Isocyanate). This is achieved by the addition of about 15% isocyanate—in most cases MDI (diphenylmethane-4,4′-diisocyanate)—to the polymer dispersion. Because of the very short “pot life” of a few hours only a short-term processing of the 2C formulation is possible in this case. By “pot life” is meant the time during which the formulation can be processed after at least one further dispersion has been mixed in.

According to the state of the art, there also are latently reactive polyisocyanate dispersions which, under certain conditions, remain stable over weeks in polychloroprene-containing 1C adhesive formulations. Appropriate products are made by Bayer Material Science AG, Leverkusen, under the designation Dispercoll® BL XP 2514 and Desmodur® XP 2589. However, it has to be taken into consideration in this case that the higher thermal stability of the glued seam does not set in until the substrates to be bonded are heated prior to or after the joining. 1C formulations which are glued at room temperature and reach a high thermal stability without heating cannot be obtained in this manner.

After the emulsion polymerisation polychloroprene dispersions are presented as strongly alkaline dispersions in the pH range of 12 to 13 and have a solids content of about 30 to 40 wt. %. For a working up to solid rubber it is required as a rule to lower the pH value to the range of pH 6 to 7. This is usually done through the addition of appropriate amounts of dilute acetic acid; mineral acids on the other hand will bring about immediate coagulation. Literature: Ullmanns Encyclopädie der technischen Chemie, Band 9, p. 366, Verlag Urban und Schwarzenberg, Munich-Berlin 1957; Encyclopedia of polymer Science and Technology, Vol. 3, pp. 705-730, John Wiley, New York 1965; Methoden der Organischen Chemie (Houben-Weyl) XIV/1, 738 ff. Georg Thieme Verlag Stuttgart 1961.

If dispersions are to be used as adhesive raw material, they have to be raised to a solids content of 54 wt. % to 60 wt. % through a creaming downstream. Also at this stage they generally have a pH value >12. Aqueous polychloropene adhesive formulations, which are used in the field of 1C sprayable adhesives, must have a pH value <10 in order to attain the characteristics profile. A lowering of the pH value with acetic acid will no longer work because of the high solids content. Only weak acids such as e.g. glycine (aminoacetic acid) can be used. In this way the adhesive formulation is diluted to an undesired degree.

Thus on top of that there was need of aqueous 1C adhesive formulations which do not have the described drawbacks, i.e. in particular there was need of formulations which are suitable for spraying and show high rapid hardening immediately after the spraying, have a long pot life, and produce bonds with high heat resistance.

The object underlying the present invention thus consisted of providing such 1C adhesive formulations.

Surprisingly, it was found that silica dispersions which were set to low pH values with strong or medium-strong acids can be mixed with strongly basic polychloroprene dispersions without coagulation. In this way 1C formulations with a high solids content and a low pH value can be prepared.

This is the more surprising given that the pH value of a formulation obtained when first a mixture of silica and polychloroprene dispersion was prepared, can no longer be lowered through the addition of strong or medium-strong acid without spontaneous coagulation.

The subject-matter of the present invention thus is a process for the preparation of dispersions, characterised in that
(a) at least one aqueous silica dispersion with a mean particle diameter of the SiO₂ particles of 1 to 200 nm is brought through the addition of at least one strong or medium-strong acid to a pH value of 6 or less, and
(b) is next mixed with at least one polychloroprene dispersion with a mean particle size of the polychloroprene particles of 50 to 200 nm.

Strong acids within the framework of the invention are preferably those which have a pK_{A} value smaller than or equal to 0. Medium-strong acids within the framework of the invention are those of which the pK_{A} value is between 0 and 4. The acids determine the equilibrium constants for the cleavage of protons in aqueous solution. Such values are accessible to the skilled person also in tables. Specified is the acidity constant pK_{A}. In the case of strong acids the pK_{A} value as a rule is less than or equal to 0, in the case of medium-strong acids it is at pK_{A} between 0 and 4, weak acids differ from these in that they generally have a pK_{A} value of more than 4, (www.cci.ethz.ch/vorlesung/de/all/node7.html). Preferably, the pH value of the silica dispersion in the process according to the invention is set through the addition of acid of which the pK_{A} value is <4, especially preferably <2.5.

Preferred strong or medium-strong acids within the framework of the present invention are acid groups-containing ion exchangers or mineral acids, such as for instance hydrochloric acid, sulfuric acid or phosphoric acids, such as e.g. ortho-phosphoric acid. Quite especially preferred is ortho-phosphoric acid. Especially preferably, the pH value of the silica dispersion is lowered through the addition of acid to a pH value of 1 to 5, quite especially preferably of 1.7 to 4.

The addition of the acid preferably takes place with stirring. The addition of the acid preferably takes place portionwise, quite especially preferably dropwise. After complete addition of the appropriate amount of acid after-stirring of the dispersion can be advantageous. This after-stirring can take place for instance over a period of a few minutes to several hours, preferably for 1 minute to 2 hours. The addition of the acid can take place at any temperature at all at which the silica dispersions are stable. Preferably, the addition of the acids takes place at room temperature.

By the term “aqueous” is meant within the framework of invention that the dispersions in essence, i.e. for at least 30 wt. %—based on the overall weight of the dispersion—contain water.

Aqueous silica dispersions are known and depending on the preparative process are present in various forms.

Suitable silica dispersions according to the invention can be obtained on the basis of silica sol, silica gel, pyrogenic silicas, precipitated silicas or mixtures of those mentioned.

Silicic acid sols are colloidal solutions of amorphic silica in water which are also called silicon dioxide sols, but mostly are called just silica sols. The silica in that case is present in the form of spherical and surface-hydroxilated particles. The particle diameter of the colloid particles as a rule is 1 to 200 nm, in which case the specific BET-surface (determined in accordance with the method of G. N. Sears, Analytical Chemistry Vol. 28, No. 12, 1981-1983, December 1956) which correlates with the particle size is 15 to 2,000 m²/g. Assuming that silica sols are presented as spherical primary particles and have a density of 2.2 g/cm³, a factor of 2,750 results. This factor divided by the specific surface gives the particle size in nm. (To determine the factor. see Ralph K. ller, The Chemistry of Silica, John Wiley & Sons New York 1979 p. 465 ff.). The surface of the SiO₂ particles has a load which is balanced by an appropriate counterion, which leads to stabilising of the colloidal solution. The alkaline-stabilised silica sols have a pH value of 7 to 11.5 and contain as alkalising agent for instance small amounts of Na₂O, K₂O, Li₂O, ammonia, organic nitrogen bases, tetraalkylammonium hydroxides or alkali or ammonium aluminates. Silica sols can also be present in weakly acid form as semistable colloidal solutions. Furthermore, it is possible to prepare cationically adjusted silica sols by coating the surfaces with Al₂(OH)₅Cl. The solids concentrations of the silica sols preferably are at 5 to 60 wt. % SiO₂.

The preparative process for silica sols in essence passes through the production steps of dealkalinisation of water glass by means of ion exchange, setting and stabilising the particle size (distribution) desired in each case of the SiO₂ particles, setting of the SiO₂ concentration desired in each case, and, optionally, a surface modification of the SiO₂ particles, such as for instance with Al₂(OH)₅Cl. In none of these steps do the SiO₂ particles leave the colloidally dissolved state. This explains the presence of the discrete primary particles.

Furthermore, a distinction is made between pyrogenic silica and precipitated silica. In the precipitation process water is present and next water glass and acid, such as H₂SO₄, are added simultaneously. In this process colloidal primary particles are formed, which agglomerate as the reaction progresses and grow into agglomerates. The specific surface as a rule is 30 to 800 m²/g (measuring specification: DIN 66131) and the primary particle size is 5 to 100 nm. The primary particles of these silicas which are presented as solids as a rule are tightly crosslinked to form secondary agglomerates. Specified is the mean particle size—also called average particle size.

Pyrogenic silica can be made by means of flame hydrolysis or with the aid of the arc process. The dominant synthesis process for pyrogenic silicas is flame hydrolysis, in which process tetrachlorosilane is decomposed in an oxyhydrogen gas flame. The silica formed in the process is X-ray amorphous. Pyrogenic silicas have clearly fewer OH groups on their virtually pore-free surfaces than precipitated silicas. Pyrogenic silica prepared by means of flame hydrolysis as a rule has a specific surface of 50 to 600 m²/g (DIN 66131) and a primary particle size of 5 to 50 nm, silica prepared by means of the arc process has a specific surface of 25 to 300 m²/g (DIN 66131) and a primary particle size of 5 to 500 nm. Also in this case the primary particles of these silicas which are presented as solids as a rule are tightly crosslinked to form secondary agglomerates. The mean particle size is specified.

Further details on the synthesis and characteristics of silicas in the solid form can be derived for instance from K. H. Büchel, H.-H. Moretto, P. Woditsch, Industrielle Anorganische Chemie, Wiley VCH Verlag 1999, Chapter 5.8.

When for the polymer dispersion according to the invention use is made of a SiO₂ raw material, such as for instance pyrogenic or precipitated silica, which is presented as an isolated solid, then this is conveyed to an aqueous SiO₂ dispersion by means of dispersing.

For the preparation of the silica dispersions use is made of state of the art dispergators, preferably those which are suitable to obtain high rates of shear, such as e.g. Ultratorrax or dissolver discs.

Preferably, use is made of those aqueous silica dispersions in process step (a) of which the SiO₂ particles have a mean particle size of 1 to 200 nm, preferably 5 to 100 nm, and especially preferably 8 to 60 nm. In the case of precipitated silicas being used, these are milled for the purpose of particle diminution. In the case of silica dispersions with a mean particle size of more than 200 nm, there is the drawback that the particles will precipitate in the resulting adhesive formulations on storage and can clog up the nozzles of the spray guns when they are used for spraying.

In the case of precipitated silicas and pyrogenic silicas the particles can be presented as so-called primary particles as well as in the form of agglomerates.

The expression “mean particle size” means according to the invention the mean particle size determined by means of ultracentrifuging and includes therein the size of primary particles and optionally present agglomerates thereof (cf.: H. G. Müller, Progr. Colloid Polym. Sci. 107, 180-188 (1997)). The mass medium is specified.

In preferred embodiments of the process according to the invention those silica dispersions are used wherein the SiO₂ particles of the silica dispersion are presented as discrete uncrosslinked primary particles. Such silica dispersions containing discrete uncrosslinked primary particles are in particular silica sols.

It is likewise preferred that the SiO₂ particles have hydroxyl groups at the particle surface.

Particularly preferably, the aqueous silica dispersions used are aqueous silica sols. Suitable silica sols are commercially available.

The preparation of polychloroprene takes place via emulsion polymerisation in an alkaline aqueous medium, cf. Ullmanns Encyclopädie der technischen Chemie, Band 9, p. 366, Verlag Urban und Schwarzenberg, Munich-Berlin 1957; Encyclopedia of Polymer Science and Technology, Vol. 3, pp. 705-730, John Wiley, New York 1965; Methoden der Organischen Chemie (Houben-Weyl) XIV/1,738 ff. Georg Thieme Verlag Stuttgart 1961.

According to the invention, use is made of polychloroprene dispersions which can be obtained by means of polymerisation of chloroprene and 0 to 20 parts by weight of a chloroprene-copolymerisable, ethylenically unsaturated monomer in an alkaline medium.

Suitable copolymerisable monomers are described e.g. in Methoden der Organischen Chemie (Houben-Weyl) XIV/1, 738 ff. Georg Thieme Verlag Stuttgart 1961. Preferred are compounds with 3 to 12 C-atoms and 1 or 2 copolymerisable C═C double bonds per molecule. Examples of preferred copolymerisable monomers are 2,3-dichlorobutadiene and 1-chlorobutadiene.

The polychloroprene dispersions to be used according to the invention are prepared by means of emulsion polymerisation at 0 to 70, preferably at 5 to 45° C., and a pH value of 10 to 14, preferably of 11 to 13. The activation takes place by means of the usual activators or activator systems known to the skilled person.

Preferably, the particles of the polychloroprene dispersion have a mean particle diameter of 60 to 180 nm.

The preparation of the polychloroprenes according to the invention can take place continuously as well as discontinuously, with continuous polymerisation being preferred.

To set the viscoity of the polychloroprenes according to the invention use can be made of conventional chain transfer agents such as mercaptans, as described e.g. in DE-A 3 002 711, GB-A 1 048 235, FR-A 2 073 106, or xanthogen disulfides, as described e.g. in DE-A 1 186 215, DE-A 2 156 453, DE-A 2 306 610 and DE-A 3 044 811, in EP-A 0 053 319, GB-A 512 458, GB-A 952 156, and U.S. Pat. No. 2,321,693 and U.S. Pat. No. 2,567,117.

The polymerisation is generally broken off at 50% to 95%, preferably at 60% to 80% of the monomer conversion, in which process e.g. phenothiazine, tert-butyl brenzcatechin or diethylhydroxylamine can be added as initiator.

After the polymerisation the remaining chloroprene monomer is removed by means of a steam distillation. It is carried out as described e.g. in W. Obrecht in Houben-Weyl: Methoden der organischen Chemie Bd. 20 Teil 3 Makromolekulare Stoffe, (1987) p. 852.

In a further step the solids content of the dispersion is increased by means of a creaming process. This creaming takes place e.g. through the addition of alginates, as described in Neoprene Latices, John C. Carl, E.I. Du Pont 1964, p. 13.

Such polychloroprene dispersions suitable for use in the adhesive sector are supplied e.g. by Bayer Material Science AG, Leverkusen under the designation Dispercoll® C 84 and Dispercoll® C 74.

Especially preferred is the use of aqueous polychloroprene dispersions which distinguish themselves through a long storage stability, i.e. of which the pH values are not significantly changed during the storage period.

The preparation of storage-stable polychloroprene dispersions is described in LeA 36711. Appropriate polychloroprene dispersions suitable for the adhesive sector are supplied e.g. by Bayer Material Science AG, Leverkusen under the designation Dispercoll® C VPLS 2325 and Dispercoll® C VPLS 2372H.

In preferred embodiments of the present invention the dispersions prepared according to the invention furthermore contain
(c) at least one water-soluble OH-groups-containing organic compound.

Such a water-soluble OH-groups-containing organic compound can either be added to the ready mixtures prepared from the addition of polychloroprene dispersion(s) to the acidified silica dispersion, or it can be added to the acidified silica dispersion with one of the two dispersions, the polychloroprene dispersion or the acidified silica dispersion, and be mixed therewith before the addition of the polychloroprene dispersion(s). The water-soluble OH-groups-containing organic compound can be added in the solid form or in the form of an aqueous solution. Also this addition preferably takes place with stirring. When the water-soluble OH-groups-containing organic compound is cyclodextrin, care should be taken that the pH value of the acidified silica dispersion is higher than 3.5.

By water-soluble hydroxyl groups-containing organic compounds are meant within the framework of invention all linear or cyclic oligomers or polymers which contain hydroxyl groups in the oligomer or polymer chain and are water-soluble. By oligomers are meant within the framework of invention those compounds with up to 10 repeating units and an molecular weight of less than 1,000, by polymers those with more than 10 repeating units and/or a molecular weight of more than 1,000, in which case the repeating units may be the same or different in both cases. Preferred examples for OH-groups-containing polymers are hydroxylalkyl celluloses, polyvinyl alcohols or polymeric cyclodextrins, preferred examples for OH-groups-containing oligomers are cyclodextrins. Preferred OH-groups-containing oligomers or polymers within the framework of the invention are cyclodextrins.

Suitable cyclodextrins are unsubstituted and substituted cyclodextrins.

Preferred cyclodextrins are \acute{α}-, β-, and γ-cyclodextrins and the ester, alkyl ether, hydroxyalkyl ether, alkoxycarbonyl alkyl ether, carboxyalkyl ether derivatives thereof or the salts thereof.

Especially preferred are methyl-\acute{α}-cyclodextrin, methyl-β-cyclodextrin, methyl-γ-cyclodextrin, ethyl-β-cyclodextrin, butyl-\acute{α}-cyclodextrin, butyl-β-cyclodextrin, butyl-γ-cyclodextrin, 2,6-dimethyl-\acute{α}-cyclodextrin, 2,6-dimethyl-β-cyclodextrin, 2,6-dimethyl-γ-cyclodextrin, 2,6-diethyl-β-cyclodextrin, 2,6-dibutyl-β-cyclodextrin, 2,3,6-trimethyl-\acute{α}-cyclodextrin, 2,3,6-trimethyl-β-cyclodextrin, 2,3,6-trimethyl-γ-cyclodextrin, 2,3,6-trioctyl-\acute{α}-cyclodextrin, 2,3,6-trioctyl-β-cyclodextrin, 2,3,6-triacetyl-\acute{α}-cyclodextrin, 2,3,6-triacetyl-β-cyclodextrin, 2,3,6-triacetyl-γ-cyclodextrin, (2-hydroxy)propyl-\acute{α}-cyclodextrin, (2-hydroxy)propyl-β-cyclodextrin, (2-hydroxy)propyl-γ-cyclodextrin, partially or wholly acetylated, methylated, and succinylated \acute{α}-, β-, and γ-cyclodextrin, 2,6-dimethyl-3-acetyl-β-cyclodextrin, and 2,6-dibutyl-3-acetyl-β-cyclodextrin.

The mono-, di- or triether-substituted, mono-, di- or triester-substituted or monoester/-diether substituted derivatives as a rule are obtained by means of etherification of \acute{α}-, β-, and γ-cyclodextrins with alkylating agents such as for instance dimethyl sulfate or alkyl halides with 1 to 30 C-atoms such as for instance methyl, ethyl, propyl, butyl, pentyl, hexyl, heptyl, octyl chloride, bromide or iodide and/or esterification with acetic acid or succinic acid in the presence of acids.

Cyclodextrins are also commercially available, for instance from Wacker (Cavamax® and Cavasol®).

The silica dispersions used in the process according to the invention preferably have a solids content of dispersed silica of 5 wt. % to 60 wt. %, preferably 30 wt. % to 51 wt. %, based on the overall weight of the silica dispersion.

In the case of the dispersions prepared according to the process according to the invention, they are dispersions which previously were not accessible in any other way. Thus the dispersions prepared according to the process according to the invention likewise are subject-matter of the present invention.

The dispersions prepared according to the process according to the invention are pre-eminently suited as components in the preparation of spray adhesives, preferably of 1C-spray adhesive formulations, since the desired coagulation does not take place until spraying and clogging up of the spraying nozzles can be prevented.

A further subject of the present invention thus is the use of these dispersions prepared according to the invention as components in the preparation of spray adhesives, preferably of 1C-spray adhesive formulations. Preferably, this preparation of spray adhesives takes place with the addition of at least one of the water-soluble OH-groups-containing organic compound(s).

When using the dispersions prepared according to the invention as components in adhesive formulations, these formulations contain silica dispersions in the range of 3 wt. % to 45 wt. %, preferably of 5 wt. %. to 35 wt. %. The polychloroprene dispersions are contained in the formulations up to 97 wt. % to 35 wt. %, preferably up to 90 wt. % to 50 wt. %, and the amounts of optionally present OH-groups-containing water-soluble organic compound(s) are 0 wt. % to 20 wt. %, preferably 5 wt. % to 15 wt. %, with the percentage values being based on the weight of non-volatile constituents and adding up to 100 wt. %.

With the dispersions prepared according to the invention adhesive formulations can be obtained which have a pH value of 8 to 10, preferably of 8.5 to 9.5, without coagulation being observed when setting the pH value. Should the target amount of silica dispersion in the formulation be insufficient to get into the desired pH range, then glycin can be used to readjust the remaining pH value difference.

The adhesive formulations prepared according to the invention can contain further additives and, optionally, coating and adhesive adjuvants.

For instance, further polymer lattices can be added in amounts up to 20 wt. %. As polymer lattices in principle all dispersions are suitable where polymers are dispersible in water with the aid of emulsifiers or dispergators, or were prepared by means of emulsion polymerisation and are presented as polymer dispersion in water. Examples are lattices of polymers made of dienes or olefinically unsaturated monomers and the copolymers thereof, such as polystyrene-butadiene-latex, acrylonitrile-butadiene-latex, latex of chlorinated polyisoprene or (meth)acrylate-latex.

Preferred are natural and synthetic polymer dispersions used in the field of adhesives, which are described in: Irving Skeist, Handbook of Adhesives 2^{nd} Edition 1977, Van Nostrand Reinhold New York,

Further suitable adjuvants which may optionally be used are for instance organic thickeners to be used in amounts of 0.01 to 1 wt. %, based on non-volatile constituents, such as cellulose derivatives, alginates, starches, starch derivatives, polyurethane thickeners or polyacrylic acids, or inorganic thickeners to be used in amounts of 0.05 to 5 wt. %, based on non-volatile constituents, such as for instance bentonites.

For conservation also fungicides can be added to the dispersions prepared according to the invention. These are used in amounts of 0.02 to 1 wt. %, based on non-volatile constituents. Suitable fungicides are for instance phenol and cresol derivatives or tin organic compounds.

Optionally, also tackifying resins, so-called adhesive resins, such as e.g. unmodified or modified natural resins such as collophonium esters, hydrocarbon resins or synthetic resins such as phthalate resins, may be added to the dispersion prepared according to the invention in dispersed form (see e.g. Klebharze, R. Jordan, R. Hinterwaldner, pp. 75-115, Hinterwaldner Verlag Munich 1994). Preferred are alkylphenol resin and terpenephenol resin dispersions with a softening point above 70° C., especially preferably above 110° C.

Also plasticisers, such as for instance those based on adipate, phthalate or phosphate, can be added to the dispersions prepared according to the invention in amounts of 0.5 to 10 parts by weight, based on non-volatile constituents.

As acceptor for small amounts of hydrogen chloride, which can be split off from the chloroprene polymerisates, epoxides such as e.g. Ruetapox® 0164 (Bisphenol-A epichlorohydrin resin MW≧700, viscosity: 8,000-13,000 mPas, supplier: Bakelite A G, Varzinger Str. 49,47138 Duisburg-Meiderich) can be used.

Through the addition of crosslinking agents, for instance polyphosphates, such as sodium hexametaphosphate, naphthaline sulfonic acid, condensation products made of napththaline sulfonic acid and formaldehyde, sodium lauryl sulfate, or ammonium or sodium polyacrylic acid salts, the stability of the adhesive formulation can be increased if need be at pH values of less than 10.

For the preparation according to the invention of the dispersions the relative amounts of the individual components are selected such that the resulting dispersion contains the individual components, such as silica dispersion, polychloroprene dispersion as well as, optionally, water-soluble OH-groups-containing organic compounds as well as, optionally, further additives or coating or adhesive adjuvants in the amounts specified above.

The individual components can, in principle, be mixed in any order.

The dispersions according to the invention are pre-eminently suitable as adhesives or coating agents for various substrates. For instance, substrates such as wood, paper, plastics, textiles, leather, rubber, or substrates made of inorganic materials such as ceramics, stoneware, glass fibres or cement can be coated or glued. When glueing substrates, substrates of the same or different type can be glued. The polymer dispersions according to the invention show a rapid initial hardening in comparison with known aqueous polymer dispersions despite the high water content and the resulting dry coating or adhesive films have a high thermal stability.

The application of the dispersions according to the invention can take place in a known manner, e.g. by means of painting, pouring, application with a doctor knife, spraying, rolling or immersing, with application by means of spraying being preferred. Drying of the coating or adhesive films can take place at room temperature or elevated temperature.

Substrates coated or glued with a polymer dispersion according to the invention are likewise subject-matter of the present invention.

The following Examples serve as elucidation of the invention by way of example and are not to be considered a limitation thereof.

### EXAMPLES

### 1.1. Substances Used

TABLE 1
silica dispersions (silica sols) of H. C. Starck GmbH, Leverkusen,
Germany

| | Silica sol | | | |
|---|---|---|---|---|
| | A | B | C | D |
| Designation | Levasil ® | Levasil ® | Levasil ® | Levasil ® |
| | 50 | 200 E | 200 B | |
| Concentration (wt. %) | 50 | 20 | 30 | 50 |
| Density (g/cm³) | 1.39 | 1.13 | 1.204 | 1.37 |
| pH value | 9 | 3.5 | 5 | 9 |
| Specific surface (m²/g) | 50 | 200 | 200 | 50 |
| Mean particle | 55 | 15 | 15 | 55 |
| size (nm) (*) | | | | |
| pH value after addition | — | 3.0 | 3.0 | 2.0 |
| of acid | | | | |

(*) Mean value, calculated from the specific surface

TABLE 2
Cyclodextrin of Wacker Burghausen Germany used as water-soluble
OH-groups-containing compound

| | |
|---|---|
| yclodextrin | E |
| Designation | Cavamax ® W6 |
| Composition | \acute{α}-cyclodextrin (cyclohexa-amylase) |
| Solids, content of cyclodextrin (%) | 90 |
| CAS-No. | 10016-20-3 |
| Molecular weight | 973 |
| Solubility in water (g) | 14.5 |
| (in 100 ml at 25° C.) | |

TABLE 3
Polymer dispersions

| | Polymer dispersion | | |
|---|---|---|---|
| | F | G | H |
| Trade name | Dispercoll ® C2325 | Acronal ® A | Simalfa ® 309 |
| | | 310S | |
| Chemical | Poly-2-chloro- | Acrylate | Adhesive |
| composition | butadiene-(1,3)-with | copolymer | formulation |
| | strong crystallisation | | based on poly- |
| | tendency | | chloroprene |
| | | | dispersion |
| | | | and acrylate |
| Manufacturer | Bayer Material | BASF | Alfa/Schweiz |
| | Science AG | | |
| Solids content | 58 | 50 | 55 |
| (%) | | | |
| pH value | 12 | 5.8 | 8.5 |

### 1.2 Measuring Methods

1.2.1. Determination of the Softening Point of the Bond (Thermal Stability)

The experiment takes place in accordance with EN 1392. From two test strips made of KASX (butadiene-acrylonitrile-rubber gummi), roughened with abrasive paper (coarseness=40) test specimens are cut, size 20×60 mm. A 100 μm thick wet film of the adhesive formulation is applied with a brush on a surface to be glued of 10×20 mm and aerated for 1 hour at room temperature. Next, the test specimens are shock-activated for 10 seconds and pressed together in such a way that only the surfaces to be glued are pressed together at an angle of 180°. The bond is pressed in the press for 10 seconds with a pressure of 4 bar (effective).

After a storage time of 3-7 days the KASX test specimens are put under a 4 kg load and tempered at 400° C. in a heating chamber within 30 minutes. Next, the test specimens are heated at a linear heating rate of 0.5° C./min to 150° C. The softening temperature, i.e. the temperature in ° C. at which the bond fails under the 4 kg load in the shear test, is registered. In all cases 4 individual measurements are carried out.

### Shock Activation

The surfaces to be glued are irradiated for 10 seconds with an IR radiator from Funk (Schockaktiviergerät 2000). The bonding takes place immediately after thermal activation of the test specimens coated with adhesive, in which process the activated layers to be glued are laid one against the other and are pressed in a press. The thus prepared test specimens are stored at 23 and 50% relative humidity.

### 1.2.2. Determination of Contact Bonding and Build-Up of Strength after Spray Application of the Adhesive Formulation

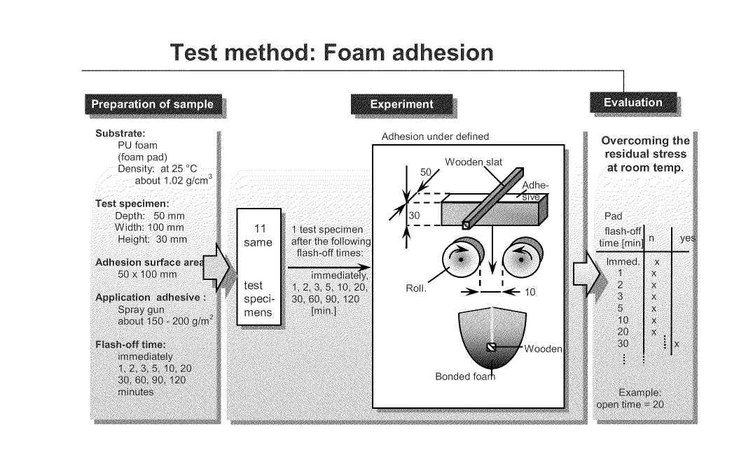

The adhesive formulations are applied on the polyurethane foam bodies with the aid of a Spray-Mix installation from Krautzberger, Eltville. The details can be derived from Bayer Material Science AG's Technical Information KA-KR-0001e/01/05.96. The coated substrates are pressed after 0-30 minutes of drying time such as described in FIG. 1 and it is determined whether the bond opens wholly or partially or whether the bond holds.

### FIG. 1: Measuring Method for the Foam-Foam Bond

In a further experiment the pressing process takes place after a drying time of and 20 minutes. Next, it is attempted to open the glued seam up again. The time is given in minutes after which the foam tears, i.e. when the bond is stronger than the foam body.

### 1.3 General Manufacturing Specifications for the Preparation According to the Invention of Adhesive Formulations

### 1.3.1 Preparation of the Acidified Silica Dispersions

For the preparation of the acidified silica dispersions according to process step (a) according to the invention, the silica-dispersions B, C or D were placed in a sealable glass bottle and 85% ortho-phosphoric acid was added dropwise until the pH value of the silica dispersion was at a pH value of 2 to 3. After a stirring time of 10 minutes the glass bottle was sealed and stored.

### 1.3.2. Preparation of the Adhesive Formulations

For the preparation of the adhesive formulations the polychloroprene dispersion was placed in a beaker. Then one after the other the additives or adjuvants, i.e. further formulation components, were added with stirring, and finally the silica dispersion was likewise added with stirring. After a storage time of 24 hours the adhesive formulation was used for the experiments.

### 1.4. Examples

### 1.4.1. Setting of the pH Value of Adhesive Formulations

TABLE 4a
Compositions of the adhesive formulations
The specified values are parts by weight of the individual components in the
respective adhesive formulations.
The adhesive formulations were prepared in accordance with the general
manufacturing specification under 1.3.2.

| | Mixture No. | | | | | | | | |
|---|---|---|---|---|---|---|---|---|---|
| | 1*) | 2*) | 3*) | 4*) | 5*) | 6*) | 7*) | 8*) | 9 |
| Polychloroprene dispersion F | 100 | 100 | 100 | 100 | 100 | 100 | 100 | 100 | 100 |
| Silica sol A | | | 30 | 30 | 30 | 30 | | | |
| Silica sol D | | | | | | | | | 30 |
| Dermulsene ® TR 602⁽³⁾ | 30 | 30 | | | | | | | |
| Acronal ® A 310 S | | | | | | | | | 30 |
| Vulkanox ® DDA 50EM⁽¹⁾ | 2 | 2 | 2 | 2 | | | | | 2 |
| Borchers LP0024⁽²⁾ | 0.5 | 0.5 | 0.5 | 0.5 | | | | | 0.5 |

*)Comparative example
Reference sources:
⁽¹⁾Rhein Chemie GmbH, Mannheim, Germany (50% diphenyl amine derivative in aqueous emulsion)
⁽²⁾Borchers GmbH, Langenfeld, Germany (alkylhydroxyl amine, 85% in water)
⁽³⁾DRT (Les Derives Resiniques + Terpeniques, Cedex, France, (terpene-phenol resin dispersion)

TABLE 4b
pH value of the adhesive formulation before and after acid addition
It was attempted to set the pH value of adhesive formulations 1-8 from Table
4a at a pH value of 9 by means of acid addition. To this end the following acids
were used:
Acetic acid as weak acid with a pK_{A} value of 4.75
Ortho-phosphoric acid as medium-strong acid with a pK_{A} value of 2.16
Adhesive formulation 9 prepared according to the invention already had a pH
value of 9.

| | Mixture No. | | | | | | | | |
|---|---|---|---|---|---|---|---|---|---|
| | 1*) | 2*) | 3*) | 4*) | 5*) | 6*) | 7*) | 8*) | 9 |
| pH value formulation | 10.7 | 10.7 | 10.4 | 10.4 | 10.6 | 10.6 | 12.0 | 12.0 | 9.0 |
| before acid addition | | | | | | | | | |
| Addition of 10% acetic | + | | + | | + | | + | | |
| acid | | | | | | | | | |
| Addition of 10% | | + | | + | | + | | + | |
| phosphoric acid | | | | | | | | | |
| Observation | C | C | C | C | C | C | C | C | |

*)Comparative example,
+ = addition of the acid to ready adhesive formulation
C = coagulation of the latex during the acid addition

As is clear in Table 4b, the pH value of the ready adhesive formulations 1-4, the silica/polychloroprene mixtures 5 and 6, as well as the pure polychloroprene dispersions 7 and 8 could be set neither by the addition of the weak acid acetic acid nor by the addition of the medium-strong acid ortho-phosphoric acid. In all cases coagulation occurred on the addition of acid. Only by a prior mixing of ortho-phosphoric with the silica dispersion could a pH value of the adhesive formulation of 9 be reached (cf. Mixture 9).

### 1.4.2. Determination of the Thermal Stability of Adhesive Formulations

TABLE 5a
Compositions of the adhesive formulations
The specified values are parts by weight of the individual components in the
respective adhesive formulations.
The adhesive formulations were prepared in accordance with the general
manufacturing specification under 1.3.2.

| | Mixture No. | | | | | | | |
|---|---|---|---|---|---|---|---|---|
| | 10*) | 11*) | 12 | 13 | 14 | 15 | 16 | 17**) |
| Polychloroprene | 100 | 100 | 100 | 100 | 100 | 100 | 100 | Simalfa ® |
| dispersion F | | | | | | | | 309 |
| Silica sol D | | | | | 30 | 30 | 30 | |
| Silica sol B | | | | 80 | | | | |
| Silica sol C | | | 80 | | | | | |
| Dermulsene ® TR 602⁽³⁾ | 30 | | | | | | | |
| Acronal ® A 310 S | | 30 | | | | 30 | 30 | |
| Cyclodextrin E | | | | | | | 10 | |
| Vulkanox ® DDA 50EM⁽¹⁾ | 2 | 2 | 2 | 2 | 2 | 2 | 2 | |
| Borchers LP0024⁽²⁾ | 0.5 | 0.5 | 0.5 | 0.5 | 0.5 | 0.5 | 0.5 | |
| Glycine | + | + | | | | | | |

*)Comparative example,
**)Prior art
Mixture 17 represents a further Comparative example according to the prior art, wherein the adhesive formulation consists of Simalfa ® 309.
Reference sources:
⁽¹⁾Rhein Chemie GmbH, Mannheim, GermanGerman (50% diphenyl amine derivative in aqueous emulsion)
⁽²⁾Borchers GmbH, Langenfeld, Germany (alkylhydroxyl amine, 85% in water)
⁽³⁾DRT (Les Derives Resiniques + Terpeniques, Cedex, France, (terpene-phenol resin dispersion)

TABLE 5b
pH value and solids content of the adhesive formulations

| | Mixture No. | | | | | | | |
|---|---|---|---|---|---|---|---|---|
| | 10*) | 11*) | 12 | 13 | 14 | 15 | 16 | 17**) |
| pH value of the | 9.3 | 9.3 | 9.3 | 9.5 | 9.2 | 9.2 | 9.2 | 8.8 |
| formulation | | | | | | | | |
| solids content | 45 | 44 | 45 | 40 | 53 | 54 | 54 | 55 |
| in wt. % | | | | | | | | |

TABLE 5c
Thermal resistance of the glued seam

| | Mixture No. | | | | | | | |
|---|---|---|---|---|---|---|---|---|
| | 10*) | 11*) | 12 | 13 | 14 | 15 | 16 | 17**) |
| Thermal | 60 | 60 | 110 | 110 | 110 | 90 | 115 | 60 |
| resistance in | | | | | | | | |
| ° C. | | | | | | | | |

In comparison with the Comparative examples (Experiments 10, 11, 17) the formulations prepared according to the invention show a clearly higher thermal resistance.

TABLE 5d
Contact adhesive time

| Drying time | mixture | | | | | | | |
|---|---|---|---|---|---|---|---|---|
| in min | 10*) | 11*) | 12 | 13 | 14 | 15 | 16 | 17**) |
| 0 | − | − | + | (+) | + | + | + | + |
| 1 | − | − | + | + | + | + | + | + |
| 3 | − | − | + | + | + | + | + | + |
| 5 | − | + | + | + | + | + | + | + |
| 10 | + | + | + | + | + | + | + | + |
| 15 | + | + | + | + | + | + | + | + |
| 20 | + | + | (+) | + | + | + | + | + |

The glued seam is fully opened again at −, slightly opened at (+), and closed at +.

In comparison with the Comparative examples (Experiments 10, 11) the formulations prepared according to the invention show a clearly better contact adhesive time in particular at shorter drying times and thus are comparable to the state of the art in this characteristic.

TABLE 5e
Build-up of strength of the bond after a drying time of 10 minutes

| Storage time after | mixture | | | | | | | |
|---|---|---|---|---|---|---|---|---|
| glueing in min | 10*) | 11*) | 12 | 13 | 14 | 15 | 16 | 17**) |
| 1 | − | − | − | − | − | − | − | − |
| 3 | − | − | − | − | − | − | (+) | − |
| 5 | − | − | (+) | − | − | (+) | (+) | (+) |
| 7 | − | − | (+) | (+) | (+) | (+) | + | (+) |
| 10 | − | (+) | + | (+) | (+) | + | + | + |
| 15 | (+) | (+) | + | + | + | + | + | + |
| 20 | (+) | + | + | + | + | + | + | + |

The bond can be separated again at −, shows partial tearing of material at (+), and tearing of material at +.

In comparison with the Comparative examples (Experiments 10, 11, 17) the bonds with the formulations prepared according to the invention show tearing of material only after long storage.

1. Process for the preparation of a dispersion, comprising:
(a) adjusting at least one aqueous silica dispersion comprising SiO₂-particles having a mean particle diameter of 1 to 200 nm to a pH value of 6 or less through the addition of at least one strong or medium-strong acid, and
(a) mixing the pH adjusted dispersion with at least one polychloroprene dispersion comprising polychloroprene particles having a mean particle size of 50 to 200 nm.

2. Process according to claim 1, wherein the SiO₂-particles have a mean particle diameter of 5 to 100 nm.

3. Process according to claim 1, wherein the aqueous silica dispersion is a silica sol.

4. Process according to claim 1, wherein the silica dispersion obtained after process step (a) has a pH value of 1 to 5.

5. Process according to claim 1, wherein the dispersion further comprises:
(c) at least one water-soluble OH-group-containing organic compound.

6. Process according to claim 5, wherein the OH-group-containing compound is one or more cyclodextrins.

7. A dispersion obtainable by the process according to claim 1.

8. A method of preparing adhesive or coating formulations comprising adding a dispersion according to claim 7 to at least one other component of said adhesive or coating formulations.

9. A method of preparing a spray adhesive formulation comprising adding a dispersion according to claim 7 to at least one other component of said spray adhesive formulation.

10. Adhesive or coating formulation containing at least one dispersion according to claim 7.

11. A substrate prepared by coating a surface of said substrate or gluing said substrate with a dispersion according to claim 7.

12. Process according to claim 2, wherein the SiO₂-particles have a mean particle diameter of 8 to 60 nm.

13. Process according to claim 4, wherein the silica dispersion obtained after process step (a) has a pH value of 1.7 to 4.

14. A method according to claim 9, wherein the spray adhesive formulation is a 1C-spray adhesive formulation.
